(19) United States
(12) Patent Application Publication
(10) Pub. No.: US 2005/0088924 A1
(43) Pub. Date: Apr. 28, 2005

(54) Optical disk apparatus, signal processing apparatus, and playback control method for optical disk apparatus

(75) Inventors: Norio Hatanaka, Yawata-shi (JP); Ryoichi Ishikawa, Kyoto-shi (JP); Nobuyuki Mitsui, Itami-shi (JP)

Correspondence Address: PARKHURST & WENDEL, L.L.P., 1421 PRINCE STREET, SUITE 210, ALEXANDRIA, VA, 22314-2805, US

(73) Assignee: Matsushita Elec. Ind. Co. Ltd., Kadoma-shi (JP)

(21) Appl. No.: 10/954,259

(22) Filed: Oct. 1, 2004

(30) Foreign Application Priority Data
Oct. 14, 2003 (JP) 2003-353038

(51) Int. Cl. G11B 7/00

(52) U.S. Cl. 369/44.25; 369/44.32

(57) ABSTRACT

Signals (A, B, C, and D) obtained by reading information recorded on an optical disk are summed and amplified by an summing amplifier (N1) to generate an RF signal. The RF signal is detected by a detection circuit (N5) to obtain an off-track sate detection signal. If the off-track state detection signal repeatedly alternates between an off-track state and an on-track state, a duty detection unit (N8) measures the duty of the off-track state detection signal. From the result, a sensitivity determining unit (N9) determines the detection sensitivity of the off-track state detection signal in the detection circuit (N5) and a detection sensitivity adjusting circuit (N6) adjusts the detection sensitivity of the off-track state detection signal in the detection circuit (N5).

### FIELD OF THE INVENTION

The present invention relates to a signal processing technology in an optical disk apparatus for reproducing information recorded on an optical disk such as a CD and DVD.

### BACKGROUND OF THE INVENTION

In recent years, inexpensive but poor-quality recording media such as CDs and DVDs of optical disk apparatuses that are problematic in property have appeared on the market. It is vital for optical disk apparatus that they can play these disks. There is an essential need for playing these disks successfully.

One characteristic of these inexpensive and poor-quality disks is that an RF signal read with an optical pickup from the pit surface of a disk includes not only light reflected from a pit being read but also light reflected from the adjacent bits.

Accordingly, when the optical pickup is not positioned over a pit during a track jump or track retraction, an RF signal including light reflected from the adjacent pits is also outputted with a sufficiently large amplitude. Consequently, an off-track detection signal, which is generated from the falling rate of the RF signal, is not outputted.

If the off-track signal and a tracking error signal (hereinafter referred to as a TE signal) based on the difference between two signals which is obtained from a displacement of the optical pickup with respect to a pit, are used in track jump and retraction operations, proper playback cannot be performed unless these signals are properly provided. As a result, information recorded on the disk cannot be reproduced.

Such a conventional optical disk apparatus will be described below.

FIG. 6 is a block diagram of an RF signal amplifier in a conventional optical disk apparatus. In FIG. 6, P1 denotes a summing amplifier, P2 denotes a subtracting amplifier, P3 denotes an equalizer, P4 denotes an AGC circuit, P5 denotes a detector circuit, P6 denotes a detection sensitivity adjusting circuit, and P7 denotes a subtracting amplifier.

When detection signals A, B, C, D, E, and F are inputted from an optical pickup (not shown) during reading data from an optical disk, the summing amplifier P1 in the RF signal amplifier sums signals A, B, C and D and amplifies them to provide an RF signal. The subtracting amplifier P2 generates the sum of signals A and C, generates a differential signal between them, and amplifies the signal to provides a focus error signal (hereinafter referred to as FE).

The equalizer P3 corrects the frequency response of the RF signal outputted from the summing amplifier P1 and outputs the resulting signal. The AGC P4 corrects a gain so that the output from the equalizer P3 has a certain amplitude and outputs the result as an ARF signal. The detection circuit P5 demodulates the RF signal and detects a period in which no RF signal is outputted, such as a period between RF signal tracks, and outputs an off-track detection signal. The detection sensitivity adjusting circuit P6 adjusts the potential for the off-track detection signal detection according to a sensitivity setting provided from an external source. The subtracting amplifier P7 generates and amplifies a differential signal between signals E and F and outputs the result as a TF signal.

A specific example of a method for adjusting the potential for off-track detection signal detection in the detection sensitivity adjusting circuit P6 and the detection circuit P5 will be described below.

FIG. 9 shows a specific exemplary configuration of the detection circuit P5 and detection sensitivity adjusting circuit P6 in FIG. 6. In FIG. 9, reference number 91 denotes the detection circuit, 92 denotes the detection sensitivity adjusting circuit, 93 denotes an AGC (automatic gain controller) for adjusting the gain of an RF signal inputted into the detection circuit 91, 94 denotes an envelope detection circuit for detecting the envelope from an RF signal outputted from the AGC 93, and 95 denotes a comparator that compares an envelope detection signal outputted from the envelope detection circuit 94 with a reference potential set by the detection sensitivity adjusting circuit 92 and binarize it to generate an off-track-state detection signal.

Signal processing in the detection circuit 91 and the detection sensitivity adjusting circuit 92 in FIG. 9 will be described with reference to FIG. 13. In FIG. 13, symbol (a) indicates an RF signal whose gain is adjusted. From an RF signal outputted from the AGC 93, an envelope as indicated by (b) is detected by the envelope detection circuit 94. The envelope detection signal (c) detected by the envelope detection circuit 94 is compared by the comparator 95 with a reference potential set by the detection sensitivity adjusting circuit 92 as indicated by (d). A signal (e) binarized by the comparison by the comparator 95 is outputted as an off-track-state detection signal.

Another example of the detection circuit P5 and the detection sensitivity adjusting circuit P6 shown in FIG. 6 may have a configuration as shown in FIG. 10. In FIG. 10, reference number 101 denotes the detection circuit, 102 denotes the detection sensitivity adjusting circuit, and 103 denotes an LPF (low-pass filter) that extracts from an RF signal component and low-frequency component inputted into the detection circuit 101, only the low-frequency component. Reference number 104 denotes an AGC that adjusts the gain of the low-frequency signal outputted from the LPF 103 and 105 denotes a comparator that compares the signal output from the AGC 104 with a reference potential set by the detection sensitivity adjusting circuit 102 to binarize the signal to generate an off-track-state detection signal.

Signal processing in the detection circuit 101 and the detection sensitivity adjusting circuit 102 will be described with reference to FIG. 14. In FIG. 14, symbol (f) indicates a signal, inputted into the detection circuit 101, having an RF signal component and a low-frequency component. The LPF 103 removes the RF signal, which is the high-frequency component, from a signal (f) inputted into the detection circuit 101 to extract the low-frequency component. The gain of the extracted low-frequency component signal (g) outputted from the LPF 103 is adjusted by the AGC 104. In the comparator 105, the signal outputted from the AGC 104 as indicated by (h) is compared with the reference potential set by the detection sensitivity adjusting circuit 102. The comparator 105 outputs a signal (i) binarized through the comparison as an off-track-state detection signal.

In the examples shown in FIGS. 9 and 10, the sensitivity of the detection circuit for detecting the off-track detection signal is adjusted by adjusting the reference potential set by the comparator in the detection circuit. Another example of a method for adjusting the sensitivity for the off-track detection signal detection in the detection circuit P5 and the detection sensitivity adjusting circuit P6 shown in FIG. 6 will be described below.

FIG. 11 shows a specific exemplary configuration of the detection circuit P5 and the detection sensitivity adjusting circuit P6 shown in FIG. 6. Reference number 111 denotes the detection circuit, 112 denotes the detection sensitivity adjusting circuit, 113 denotes an AGC for adjusting the gain of an RF signal inputted into the detection circuit 111, 114 denotes an envelope detection circuit that detects the envelope from the RF signal outputted from the AGC 113, 115 denotes a signal adding unit that adds an adjustment signal set by the detection sensitivity adjusting circuit 112 to the envelope signal outputted from the envelope detection circuit 114, and 116 denotes a comparator that compares the signal outputted from the signal adding unit 115 with a reference potential Vref to binarize the signal and generates it as an off-track-state detection signal.

Signal processing in the detection circuit 111 and the detection sensitivity adjusting circuit 112 in FIG. 11 will be described with reference to FIG. 13. In FIG. 13, symbol (a) indicates an RF signal whose gain is adjusted by the AGC 113. The envelope of the RF signal outputted from the AGC 113 is detected by the envelope detection circuit 114 as indicated by (b). An adjustment signal set by the detection sensitivity adjusting circuit 112 is added by the signal adding unit 115 to the detected envelope signal (c) detected by the envelope detection circuit 114. As indicted by (d), the signal outputted from the signal adding unit 115 is compared with a reference potential by a comparator 116. A signal (e) binarized through the comparison by the comparator 116 is outputted as an off-track-state detection signal.

Another example of the detection circuit P5 and the detection sensitivity adjusting circuit P6 shown in FIG. 6 may have a configuration shown in FIG. 12. In FIG. 12, reference number 121 denotes the detection circuit, 122 denotes the detection sensitivity adjusting circuit, 123 denotes an LPF that extracts only a low-frequency component from an RF signal component and the low-frequency component inputted into the detection circuit 121, 124 denotes a signal adding unit that adds an adjustment signal set by the detection sensitivity adjusting circuit 122 to the output from the LPF 123, 125 denotes an AGC that adjusts the gain of the low-frequency signal outputted from the signal adding unit 124, and 126 denotes a comparator that compares the output from the AGC 125 with a reference potential Vref to binarize it to generate an off-track-state detection signal.

Signal processing in the detection circuit 121 and the detection sensitivity adjusting circuit 122 shown in FIG. 12 will be described with reference to FIG. 14. In FIG. 14, symbol (f) indicates a signal, inputted into the detection circuit 121, having an RF signal component and a low-frequency component. The LPF 123 removes the RF signal, which is the high-frequency component, from the signal (f) inputted in to the detection circuit 121 to extract the low-frequency component. An adjustment signal set by the detection sensitivity adjusting circuit 122 is added by the signal adding unit 124 to the extracted low-frequency component signal (g) outputted from the LPF 123. The gain of the output from the signal adding unit 124 is adjusted by the AGC 125. In the comparator 126, the output from the AGC 125 is compared with as the reference potential Vref set by the detection sensitivity adjusting circuit as indicated by (h). The comparator 126 outputs a signal (i) binarized through the comparison as an off-track-state detection signal.

In the examples shown in FIGS. 11 and 12, an adjustment signal is set by the detection sensitivity adjusting circuit and added to a signal before being binarized by the comparator, thereby adjusting the detection sensitivity of the off-track-state detection signal. The envelope circuits in FIGS. 9 and 11 and the LPFs in FIGS. 10 and 12 can be construed as low-frequency component signal extracting unit for extracting a low-frequency component from a signal read from an optical signal.

A TE signal and an off-track-state detection signal during playing a disk that are adequately outputting the off-track-state signal in an optical disk apparatus will be described below with reference to FIG. 7.

FIG. 7 is a waveform diagram showing a TE signal and an off-track signal when an optical pickup is passing over a pit. In FIG. 7, reference number 71 denotes a TE signal, 72 denotes an on-track point at which the laser beam is positioned on a pit, and 73 denotes an off-track-state detection. The off-track-state detection signal 73 exhibits different polarities depending on whether the laser beam is on or off the track. A servo control chip determines the current position of the laser beam from the TE signal 71 and off-track-state detection signal 73, and performs a track jump or track retraction.

FIG. 8 is a waveform diagram showing a TE signal and an off-track-state detection signal when the pickup is passing over a pit in a disk that has a difficulty in outputting an off-track-state detection signal. In FIG. 8, reference number 81 denotes a TE signal, 82 is an on-track point at which the laser beam is positioned on a pit, and 83 denotes an off-track-state detection signal. Because an off-track-state detection signal does not readily rise in this disk, adjustment of the detection sensitivity of the off-track-state detection signal is required.

Other prior-art optical disk apparatuses (see Japanese Patent Laid-Open No. 6-243483, for example) set a target position during a track jump in order to provide a stable, accurate track jump even under disturbance.

However, in prior-art optical disk apparatuses such as the one described in the Japanese Patent Laid-Open No. 6-243483, only a target position is set in order to achieve a stable, accurate track jump in case of disturbances. If the pickup is displaced from a target position by a disturbance or vibration, the direction of the displacement cannot be determined by counting the number of tracks with a TE signal alone. Therefore the number of tracks between the target position and the position of the displaced pickup cannot accurately be calculated and control for a stable, accurate track jumping operation cannot be provided.

On the other hand, a track counting method in which an off-track state detection signal is used in combination with a TE signal enables a more precise track jumping operation because the direction of a displacement can be detected and the number of tracks between a target position and the position of a displaced pickup can accurately be calculated. However, this method requires the waveform of the off-track state detection signal be established and the detection sensitivity of the off-track signal be adjusted as described earlier.

Thus, in a poor-quality disk from which an off-track state detection signal is not properly outputted, the number of tracks may be miscounted and accordingly a servo control chip may erroneously determine the current position of a laser beam and may not be able to perform accurate track jumping and retracting operation, resulting in improper playback.

### DISCLOSURE OF THE INVENTION

The present invention solves the above-described problem with the prior art. An object of the present invention is to provide an optical disk apparatus, signal processing apparatus, and a playback control method for the optical disk apparatus that allow a disk unplayable with the prior-art technologies to be reliably played without impairing fast track jumping and retracting operations with an off-state detection signal.

In order to solve the problem describe above, an optical disk apparatus of the present invention includes a signal reading unit for reading a signal form information recorded on an optical disk, an off-track state detection signal generating unit for generating an off-track state detection signal based on a signal provided from the signal reading unit, and a duty measuring unit for measuring the duty of the off-track state detection signal if the off-track state detection signal from the off-track state detection signal generating unit repeatedly alternates between an off-track state and an on-track state, wherein the detection sensitivity of the off-track state detection signal generating unit is adjusted according to the duty measured by the duty measuring unit.

An optical disk apparatus playback control method of the present invention is a playback control method for the optical disk apparatus described above, wherein the sensitivity adjustment is disabled if the optical disk is of a type that does not require optimization of the detection sensitivity of the off track state detection signal.

An optical disk playback apparatus of the present invention optimizes the detection sensitivity of the off-track state detection signal by switching between enabling and disabling the sensitivity adjustment by using the optical disk apparatus playback control method described above.

A signal processing apparatus of the present invention includes an input unit for inputting a signal obtained from information recorded on an optical disk, an off-track state detection unit for generating an off-track state detection signal based on a signal provided from the input unit, and a duty measuring unit for measuring the duty of the off-track state detection signal if the off-track state detection signal from the off-track state detection signal generating unit repeatedly alternates between an off-track state and an on-track state, wherein the detection sensitivity of the off-track state detection signal generating unit is adjusted according to the duty measured by the duty measuring unit.

Another optical disk playback control method of the present invention is a playback control method for an optical disk apparatus using the signal processing apparatus described above, wherein the sensitivity adjustment is disabled if the optical disk is of a type that does not require optimization of the detection sensitivity of the off track state detection signal.

As has been described, the detection sensitivity of an off-track state detection signal is adjusted to an optimum value for each disk. This allows accurate track jumping and retracting operations to be performed even in disks unable to be played back with an off-track state detection signal with detection sensitivity preset in a design state.

Consequently, a disk unplayable with the prior-art technologies can be reliably played without impairing fast track jumping and retracting operations with an off-state detection signal.

### BRIEF DESCRIPTION OF THE DRAWINGS

FIG. 1 is a block diagram showing a configuration of an RF signal amplifier in an optical disk apparatus according to a first embodiment of the present invention;

FIG. 2 is a block diagram showing a configuration of a duty detecting unit in the optical disk apparatus according to the first embodiment;

FIG. 3 is a block diagram showing another configuration of the duty detecting unit in the optical disk apparatus according to the first embodiment;

FIG. 4 is a block diagram showing yet another configuration of the duty detecting unit in the optical disk apparatus according to the first embodiment;

FIG. 5 is a block diagram showing a configuration of an RF signal amplifier in an optical disk apparatus according to a second embodiment of the present invention;

FIG. 6 is a block diagram showing a configuration of an RF signal amplifier in an optical disk apparatus according to a prior art;

FIG. 7 is a waveform diagram of a TE signal and an off-track state detection signal during normal disk playback in the optical disk apparatus according to the prior art;

FIG. 8 is a waveform diagram of a TE signal and an off-track state detection signal during disk playback in the optical disk apparatus according to the prior art when adjustment of the detection sensitivity of the off-track state detection signal is required;

FIG. 9 is a block diagram showing a first exemplary configuration of a detection circuit and a detection sensitivity adjusting circuit in an optical disk apparatus;

FIG. 10 is a block diagram showing a second exemplary configuration of the detection circuit and the detection sensitivity adjusting circuit in the optical disk apparatus;

FIG. 11 is a block diagram showing a third exemplary configuration of the detection circuit and the detection sensitivity adjusting circuit in the optical disk apparatus;

FIG. 12 is a block diagram showing a fourth exemplary configuration of the detection circuit and the detection sensitivity adjusting circuit in the optical disk apparatus;

FIG. 13 is a waveform diagram showing a process for creating an off-track state detection signal in the configurations shown in FIGS. 9 and 11; and

FIG. 14 is a waveform diagram showing a process for creating an off-track state detection signal in the configurations shown in FIGS. 10 and 12.

### DESCRIPTION OF THE EMBODIMENTS

An optical disk apparatus, a signal processing apparatus, and a playback control method for the optical disk apparatus according to embodiments of the present invention will be described in detail with reference to the accompanying drawings.

(First Embodiment)

An optical disk apparatus, a signal processing apparatus, and a playback control method for the optical disk apparatus according to a first embodiment of the present invention will be described.

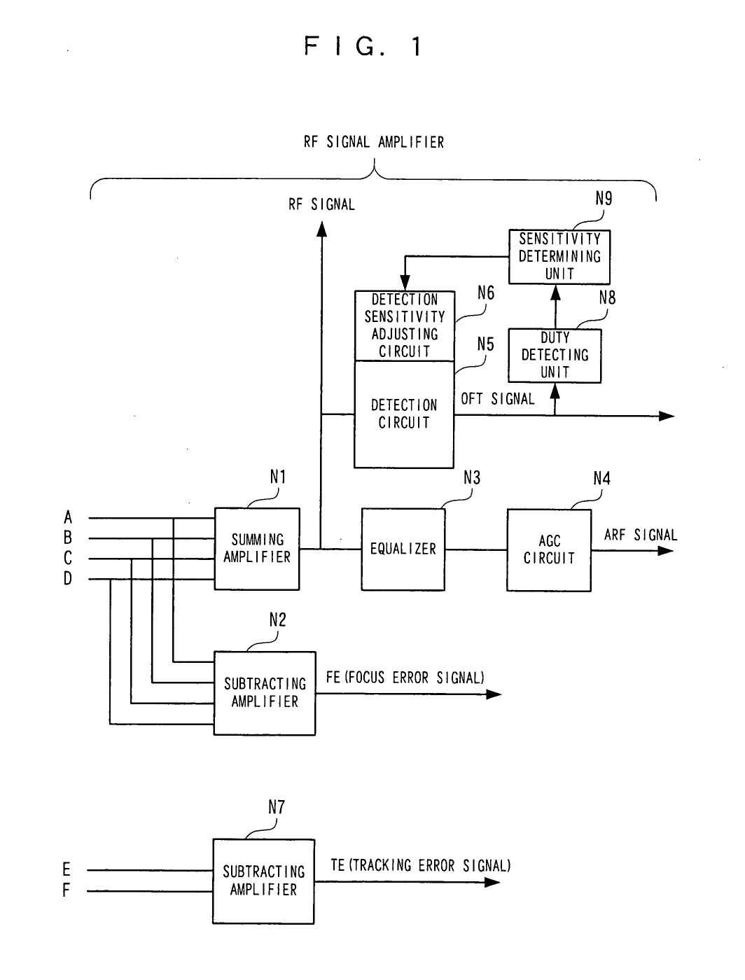

FIG. 1 is a block diagram of an RF signal amplifier of an optical disk apparatus according to the first embodiment. In FIG. 1, symbol N1 denotes a summing amplifier, N2 denotes a subtracting amplifier, N3 denotes an equalizer, N4 denotes an AGC circuit, N5 denotes a detection circuit, N6 denotes a detection sensitivity adjusting circuit, N7 denotes a subtracting amplifier, N8 denotes a duty detecting unit, and N9 denotes a sensitivity determining unit.

Operations of the summing amplifier N1, subtracting amplifier N2, equalizer N3, AGC circuit N4, detection circuit N5, detection sensitivity adjusting circuit N6, and subtracting amplifier N7 are the same as the summing amplifier P1, subtracting amplifier P2, equalizer P3, AGC circuit P4, detection circuit P5, detection sensitivity adjusting circuit P6, and subtracting amplifier P7 of the prior art and therefore the description of which will be omitted. When the duty detection unit N8 detects that an off-track state detection signal outputted from the detection circuit N5 continuous changes between a high and a low potential, the duty detection unit N8 measure the duty of the signal and provides the result to the sensitivity determining unit N9. The sensitivity determining unit N9 determine the detection sensitivity of the current off-track state detection signal from the duty of the off-track state detection signal and sets the sensitivity in the detection sensitivity adjusting circuit N6 to a predetermined optimum value.

The state in which the off-track state detection signal changes between the high and low potential appears during a search or track jumping operation, rather than during tracing tracks for reading data on an optical disk. The RF signal amplifier of the first embodiment automatically adjusts the detection sensitivity of the off-track state detection signal each time the change appears.

An exemplary configuration of the duty detecting unit in the optical disk apparatus will be described in which an off-track state detection signal is sampled and the high and low potential states of the sampled values are counted for duty detection.

FIG. 2 is a block diagram of the duty detecting unit that a counting circuit to perform detection. In FIG. 2, reference number 21 denotes a sampling circuit that samples an off-track state signal at predetermined intervals and outputs sampled values, 22 denotes a counting circuit that counts 1s and 0s of the sampled values and outputs the numbers of 1s and 0s, 23 denotes a calculating circuit that calculates the ratio between the numbers of 1s and 0s, and 24 denotes a comparing circuit that compares the ratio provided from the calculation circuit with a predetermined target ratio and outputs a match, difference, or ratio as an adjustment directing signal to the detection sensitivity adjusting circuit N6.

Another exemplary configuration of the duty detection unit in the optical disk apparatus will be described in which the high and low potentials of an off-track state detection signal are used to perform switching between charge and discharge of an electric capacitance for duty detection.

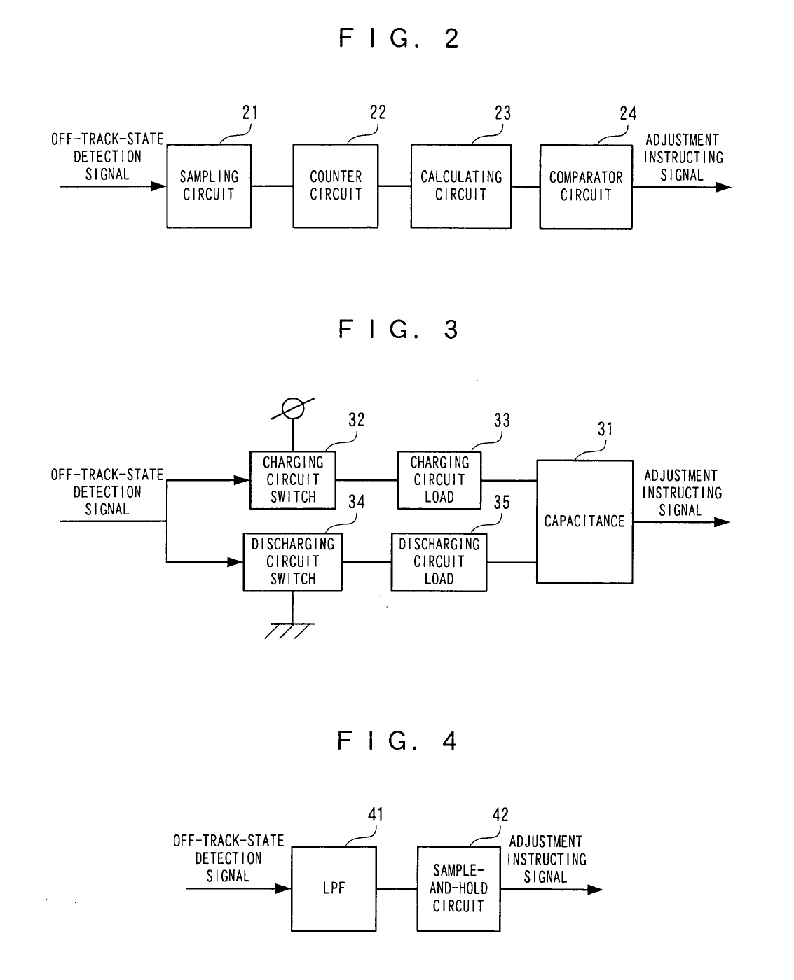

FIG. 3 is a block diagram of the duty detecting unit in which switching between a charge and discharge of an electric capacitance is used for duty detection. In FIG. 3, reference number 31 denotes an electric capacitance that holds accumulated charges by charging or discharging and outputs a potential as an adjustment directing signal to the detection sensitivity adjusting circuit N6, 32 denotes a charging circuit switch that short-circuits the line between a power source to the electric capacitance 31 for charging when the potential of an off-track state detection signal is high and opens the line to stop discharging when the potential is low, 33 denotes a charging current load that determines a current in charging, 34 denotes a discharging circuit switch that short-circuits the line between the electric capacitance 31 and a ground for discharging when the potential of the off-track state detection signal is low and opens the line to stop discharging when the potential is high, and 35 denotes a discharging current load that determines a current in discharging.

The larger the high-potential portion of the off-track state detection signal, the larger the amount of charge to the electric capacitance 31 exceeds the amount of discharge from the electric capacitance 31. Consequently, more charge accumulates in the electric capacitance 31 and the potential of the adjustment directing signal outputted from the electric capacitance 31 to the detection sensitivity adjusting circuit N6 increases. On the other hand, the larger the low-potential portion of the off-track state detection signal, the larger the amount of discharge from the electric capacitance 31 exceeds the amount of charge to the electric capacitance 31. Consequently, more charge of the electric capacitance 31 escapes and the potential of the adjustment directing signal outputted from the electric capacitance 31 to the detection sensitivity adjusting circuit N6 decreases.

Another exemplary configuration of the duty detection unit in the optical disk apparatus will be described in which a low-pass filter (LPF) and a sample-and-hold circuit are used for duty detection.

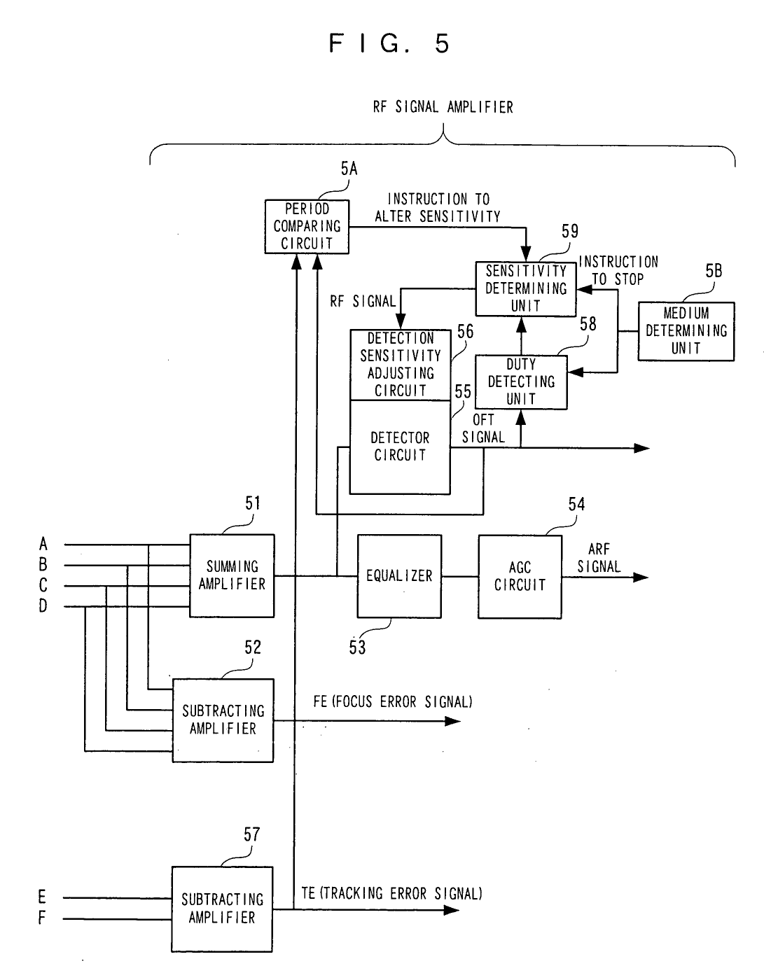

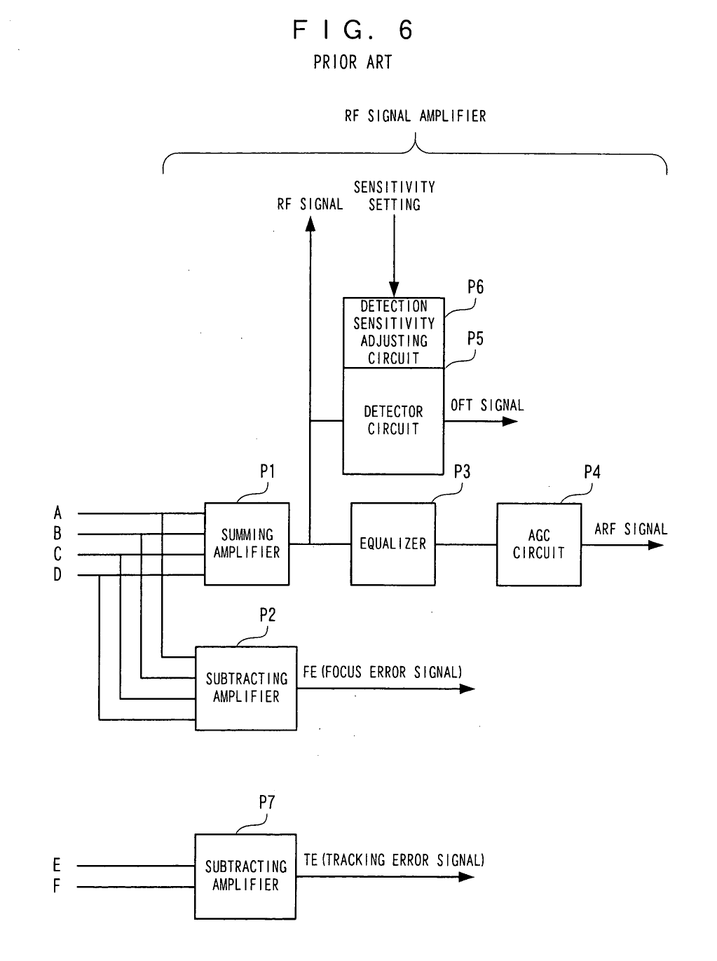

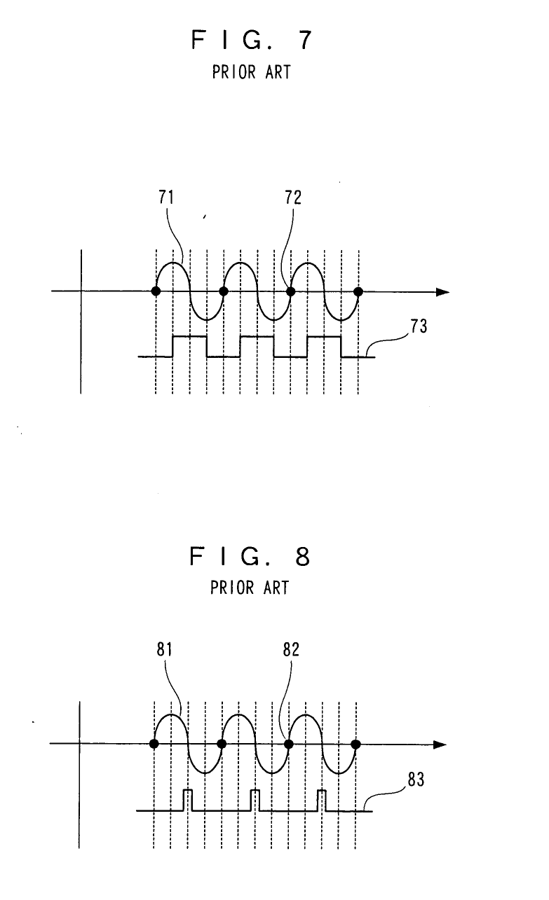

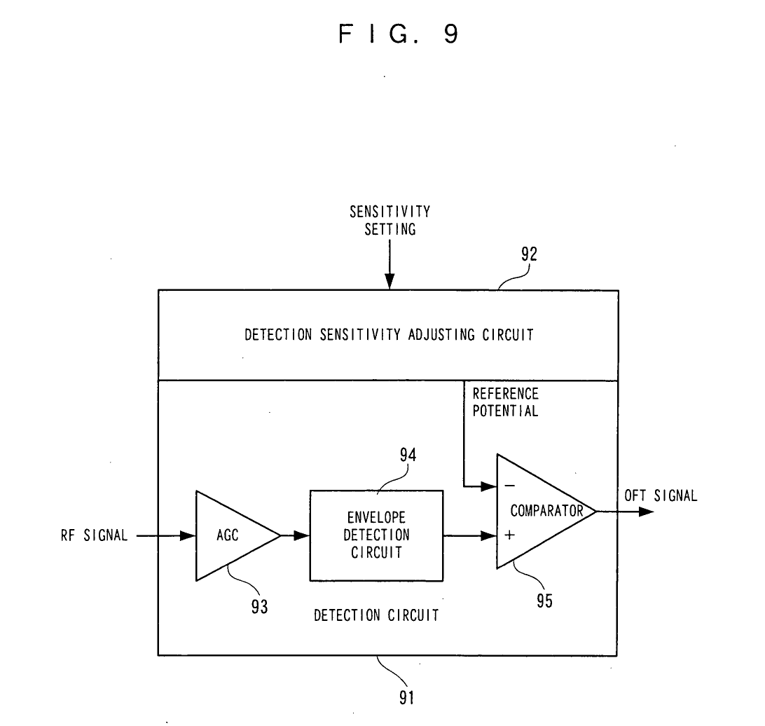

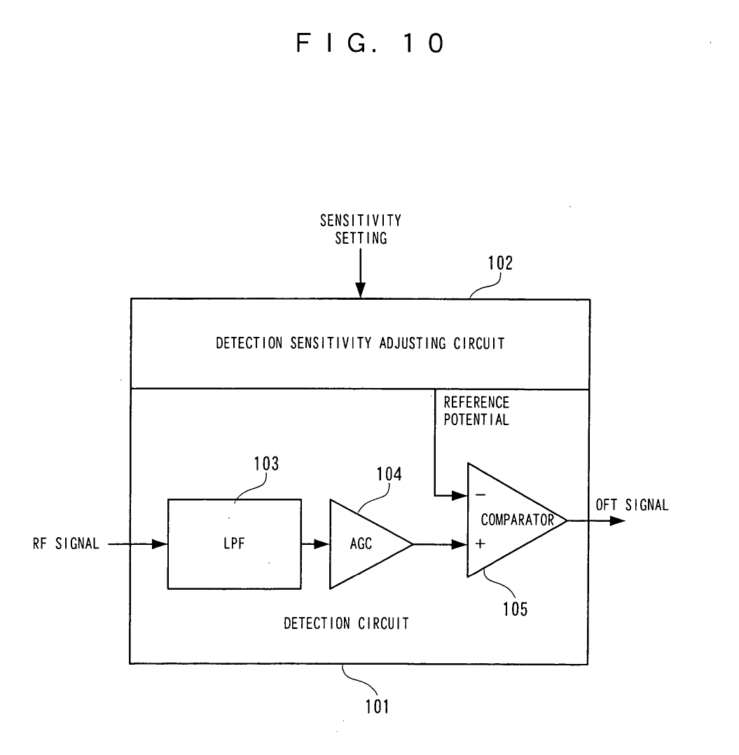

FIG. 4 is a block diagram of the duty detecting unit in which sample and hold is used for duty detection. In FIG. 4, reference number 41 denotes an LPF and 42 denotes a sample-and-hold circuit.

If the duty of an off-track state detection signal is 1:1, for example, the potential of the direct current component of the signal filtered by the LPF 41 will be at the midpoint between the higher and lower potential of the off-track detection signal. Otherwise, the direct current component appears as the offset component at the higher or lower potential whichever has the wider pulse width. The potential is held by the sample-and-hold circuit 42 and outputted as an adjustment signal to the detection sensitivity adjusting circuit N6 to adjust the detection sensitivity of the off-track state detection signal.

(Second Embodiment)

An optical disk apparatus, a signal processing apparatus, and a playback control method for the optical disk apparatus according to a second embodiment of the present invention will be described below.

FIG. 5 is a block diagram of an RF signal amplifier of the optical disk apparatus of the second embodiment. In FIG. 5, reference number 51 denotes a summing amplifier, 52 denotes subtracting amplifier, 53 denotes equalizer, 54 denotes an AGC circuit, 55 denotes a detection circuit, 56 denotes detection sensitivity adjusting circuit, 57 denotes subtracting amplifier, 58 denotes a duty detecting unit, and 59 denotes a sensitivity determining unit. Operations of the components, from the summing amplifier 51 to the sensitivity determining unit 59 are the same as those in the first embodiment and therefore the description of which will be omitted.

A period comparing circuit 5A compares the period of an off-track state detection signal and that of a tracking error signal. If they differ, the sensitivity determining unit 59 outputs an instruction to alter the sensitivity. For example, if the period of the off-track state detection signal is longer than that of the tracking error signal, the sensitivity determining unit 59 determines that the detection sensitivity is too low and provides an instruction to shift the sensitivity substantially toward the higher value. On the other hand, if it is shorter, the sensitivity determining unit 59 determines that the sensitivity is higher than necessary and provides an instruction to shift the sensitivity toward the lower value. The adjustment of the detection sensitivity of the off-track state detection signal is repeated until fluctuations in the duty converge to a certain value or within a certain range, that is, the period of the off-track detection signal stabilizes at a certain value or within a certain range, thereby providing operation at the optimum sensitivity setting.

In some types of disks such as CD-Rs and CD-RWs, the period of the off-track state detection signal widely varies among manufactures or materials, in optical characteristics of recorded disk surfaces such as light reflectivity, refractivity, diffusibility, transmittance, and so on. In commercially available CD-DAs and CD-ROMs, however, the period does not significantly vary. Therefore, the need for adjustment of the detection sensitivity of the off-track state detection signal can be eliminated by setting the initial value of the sensitivity to that of CD-DAs.

In FIG. 5, if a CD-DA is used, the medium determining unit 5B outputs a stop instruction signal to cause the duty detecting unit 58 and the sensitivity determining unit 59 to stop operating and accordingly adjustment of the detection sensitivity of the off-track state detection signal is not performed. This can save the time required for adjusting the sensitivity during initial operation.

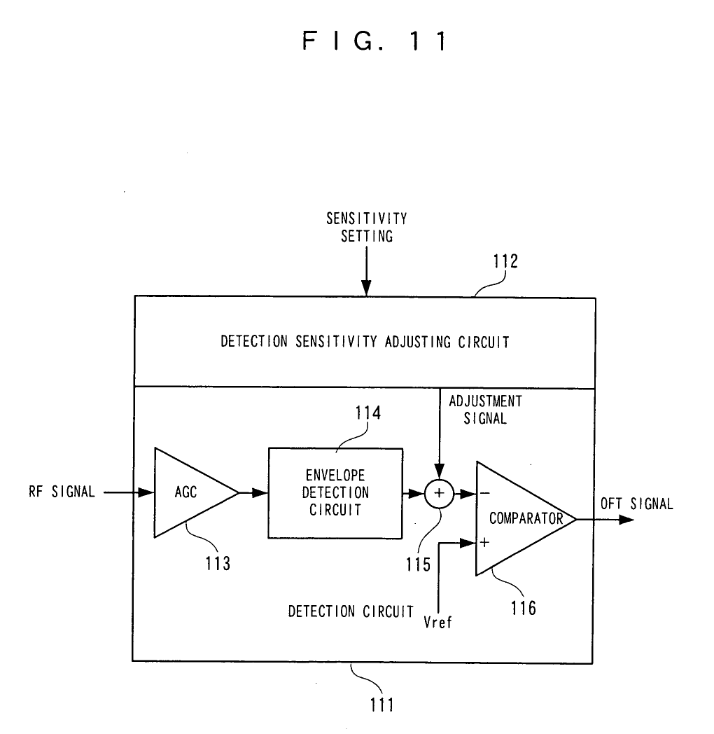

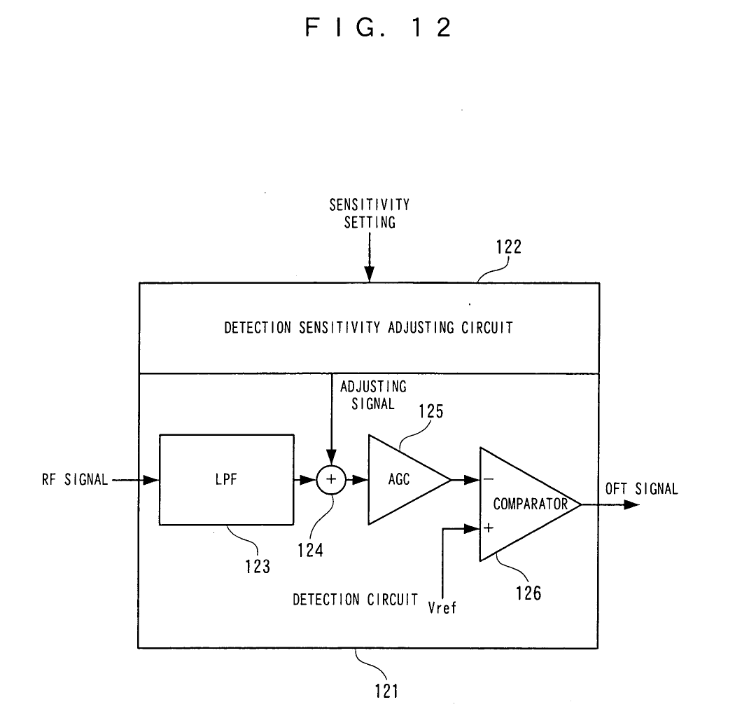

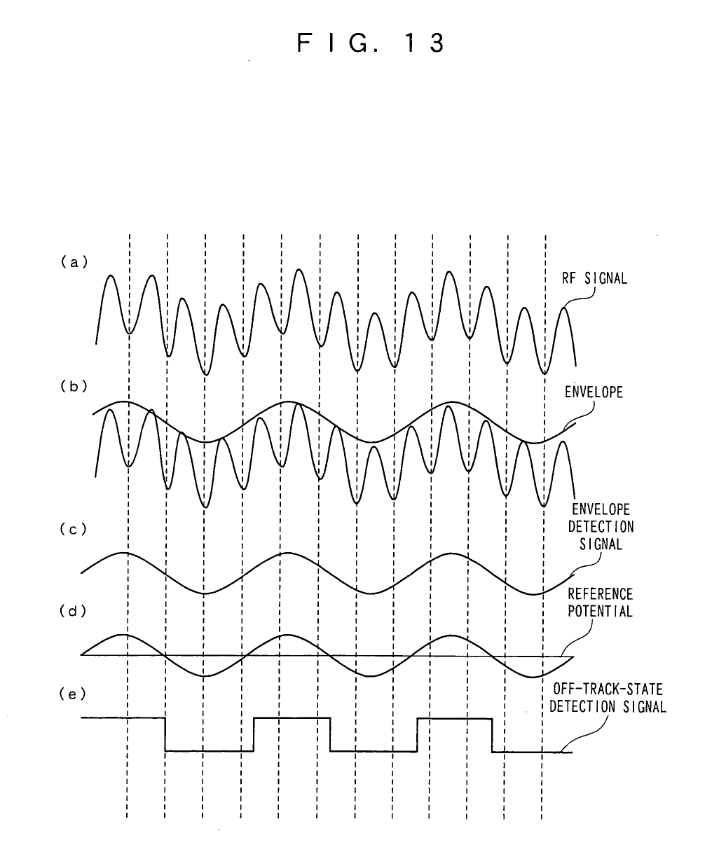

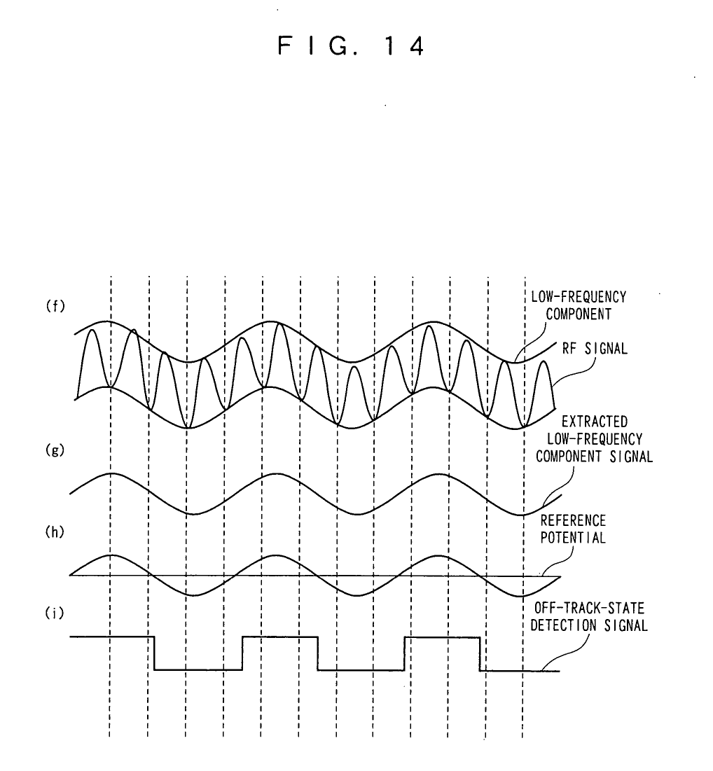

The detection circuits N5 and 55 and the detection sensitivity adjusting circuits N6 and 56 in the embodiments described above can be implemented with any of configurations as shown in FIGS. 9 to 12. With the configuration shown in FIG. 9 or the configuration shown in FIG. 10, the detection sensitivity adjusting circuit N6, 56 can set the sensitivity by setting a reference potential to be provided to the comparator 95, 105 of the detection circuit 91, 101. With the configuration shown in FIG. 11 or the configuration shown in FIG. 12, the detection sensitivity adjusting circuit N6, 56 can set the sensitivity by setting an adjustment signal to be added to a signal before binarized by the comparator 116, 126 of the detection circuit 111, 121.

1. An optical disk apparatus comprising:
a signal reading unit for reading a signal form information recorded on an optical disk;
an off-track state detection signal generating unit for generating an off-track state detection signal based on a signal provided from said signal reading unit; and
a duty measuring unit for measuring the duty of said off-track state detection signal if said off-track state detection signal from said off-track state detection signal generating unit repeatedly alternates between an off-track state and an on-track state, wherein
the detection sensitivity of said off-track state detection signal generating unit is adjusted according to said duty measured by said duty measuring unit.

2. The optical disk apparatus according to claim 1, wherein said duty measuring unit samples said off-track state detection signal and counts the high and low potential states of the off-track state detection signal.

3. The optical disk apparatus according to claim 1, wherein said duty measuring unit performs switching between charge and discharge of an electric capacitance according to the high and low potential states of said off-track state detection signal.

4. The optical disk apparatus according to claim 1, wherein said duty measuring unit passes said off-track state detection signal through a low-pass filter and samples and holds the resulting signal to generate a direct-current potential.

5. The optical disk apparatus according to claim 1, further comprising a sensitivity determining unit for determining, based on the duty of said off-track state detection signal, the off-track state detection state signal detection sensitivity in the off-track state detection signal generating unit.

6. The optical disk apparatus according to claim 5, further comprising a sensitivity adjusting unit for adjusting the off-track state detection state signal detection sensitivity in the off-track state detection signal generating unit according to the detection sensitivity determined by said sensitivity determining unit.

7. The optical disk apparatus according to claim 6, wherein said off-track state detection signal generating unit comprises a low-frequency-component extracting unit for extracting a low-frequency-component signal from a signal provided from said signal reading unit, and a comparing unit for comparing a signal based on the low-frequency-component signal extracted by said low-frequency-component extracting unit with a reference potential, whereby a signal obtained from said comparing unit is provided as an off-track state detection signal.

8. The optical disk apparatus according to claim 7, wherein the detection sensitivity of said off-track state detection signal generating unit is adjusted by adjusting a reference potential provided to said comparing unit.

9. The optical disk apparatus according to claim 7, wherein said off-track state detection unit comprises a signal adding unit for adding an adjustment signal outputted from said sensitivity adjusting unit to the low-frequency component signal extracted by said low-frequency-component extracting unit, wherein the detection sensitivity of said off-track state detection signal generating unit is adjusted by adding said adjustment signal by said signal adding unit and a signal generated by said signal adding unit is compared with the reference potential by said comparing unit.

10. The optical disk apparatus according to claim 6, further comprising a tracking error signal generating unit for generating a tracking error signal based on a signal provided from said signal reading unit, and a sensitivity altering unit for comparing the period of said off-track state detection signal with the period of the tracking error signal from said tracking error signal generating unit and, if the periods substantially differ from each other, increasing the initial adjustment amount during detection sensitivity adjustment in said sensitivity adjusting unit.

11. The optical disk apparatus according to claim 6, wherein said sensitivity adjusting unit repeats the adjustment of the detection sensitivity of said off-track state detection signal until fluctuations in the duty of said off-track state detection signal converge to a certain range.

12. The optical disk apparatus according to claim 6, further comparing a switching unit for performing switching between enabling and disabling the off-track state detection signal duty measurement in said duty measuring unit or between enabling and disabling the off-track state detection signal sensitivity adjustment in said sensitivity adjusting unit.

13. A playback control method for the optical disk apparatus of claim 12, wherein said sensitivity adjustment is disabled if said optical disk is of a type that does not require optimization of the detection sensitivity of said off track state detection signal.

14. An optical disk playback apparatus for optimizing the detection sensitivity of said off-track state detection signal by switching between enabling and disabling said sensitivity adjustment by using the optical disk apparatus playback control method of claim 13.

15. A signal processing apparatus comprising:
an input unit for inputting a signal obtained from information recorded on an optical disk;
an off-track state detection unit for generating an off-track state detection signal based on a signal provided from said input unit; and
a duty measuring unit for measuring the duty of said off-track state detection signal if said off-track state detection signal from said off-track state detection signal generating unit repeatedly alternates between an off-track state and an on-track state, wherein
the detection sensitivity of said off-track state detection signal generating unit is adjusted according to said duty measured by said duty measuring unit.

16. The signal processing apparatus according to claim 15, wherein said duty measuring unit samples said off-track state detection signal and counts the high and low potential states of the off-track state detection signal.

17. The signal processing apparatus according to claim 15, wherein said duty measuring unit performs switching between charge and discharge of an electric capacitance according to the high and low potential states of said off-track state detection signal.

18. The signal processing apparatus according to claim 15, wherein said duty measuring unit passes said off-track state detection signal through a low-pass filter and samples and holds the resulting signal to generate a direct-current potential.

19. The signal processing apparatus according to claim 15, further comprising a sensitivity determining unit for determining, based on the duty of said off-track state detection signal, the off-track state detection state signal detection sensitivity in the off-track state detection signal generating unit.

20. The signal processing apparatus according to claim 19, further comprising a sensitivity adjusting unit for adjusting the off-track state detection state signal detection sensitivity in the off-track state detection signal generating unit according to the detection sensitivity determined by said sensitivity determining unit.

21. The signal processing apparatus according to claim 20, wherein said off-track state detection signal generating unit comprises a low-frequency-component extracting unit for extracting a low-frequency-component signal from a signal provided from said input unit, and a comparing unit for comparing a signal based on the low-frequency-component signal extracted by said low-frequency-component extracting unit with a reference potential, whereby a signal obtained from said comparing unit is provided as an off-track state detection signal.

22. The signal processing apparatus according to claim 21, wherein the detection sensitivity of said off-track state detection signal generating unit is adjusted by adjusting a reference potential provided to said comparing unit.

23. The signal processing apparatus according to claim 21, wherein said off-track state detection unit comprises a signal adding unit for adding an adjustment signal outputted from said sensitivity adjusting unit to the low-frequency component signal extracted by said low-frequency-component extracting unit, wherein the detection sensitivity of said off-track state detection signal generating unit is adjusted by adding said adjustment signal by said signal adding unit and a signal generated by said signal adding unit is compared with the reference potential by said comparing unit.

24. The signal processing apparatus according to claim 20, further comprising a tracking error signal generating unit for generating a tracking error signal based on a signal provided from said signal reading unit, and a sensitivity altering unit for comparing the period of said off-track state detection signal with the period of the tracking error signal from said tracking error signal generating unit and, if the periods substantially differ from each other, increasing the initial adjustment amount during detection sensitivity adjustment in said sensitivity adjusting unit.

25. The signal processing apparatus according to claim 20, wherein said sensitivity adjusting unit repeats the adjustment of the detection sensitivity of said off-track state detection signal until fluctuations in the duty of said off-track state detection signal converge to a certain range.

26. The signal processing apparatus according to claim 20, further comprising a switching unit for performing switching between enabling and disabling the off-track state detection signal duty measurement in said duty measuring unit or between enabling and disabling the off-track state detection signal sensitivity adjustment in said sensitivity adjusting unit.

27. An playback control method for an optical disk apparatus using the signal processing apparatus of claim 26, wherein said sensitivity adjustment is disabled if said optical disk is of a type that does not require optimization of the detection sensitivity of said off track state detection signal.
